(19) United States
(12) Patent Application Publication
(10) Pub. No.: US 2020/0349873 A1
(43) Pub. Date: Nov. 5, 2020

(54) CLIENT DEVICES HAVING SPIN RELATED FUNCTIONALITIES AND RELATED METHODS

(71) Applicant: PopSockets LLC, Boulder, CO (US)

(72) Inventors: Altan Nahum, Boulder, CO (US); David B. Barnett, Boulder, CO (US)

(21) Appl. No.: 16/864,924

(22) Filed: May 1, 2020

Related U.S. Application Data
(60) Provisional application No. 62/841,580, filed on May 1, 2019.

(51) Int. Cl. G09G 3/00; G06F 3/0487; G06F 3/0484

(52) U.S. Cl. CPC G09G 3/001; G06F 3/04845; G06F 3/0487

(57) ABSTRACT

Portable client devices, software operating on such devices, and methods are described herein that utilize rotational data of the device to at least partially control the output on a display of the device. More specifically, when operating the software, a rotation measurement device, such as an accelerometer and/or gyroscope, within the device can determine when a user rotates or spins the device and, in some versions, how fast a user rotates or spins the device, and thereafter a processing device can cause the display or portions thereof to be stabilized or spun using the rotational characteristics as input.

### CROSS-REFERENCE TO RELATED APPLICATION

This application claims the benefit of U.S. Provisional Application No. 62/841,580, filed on May 1, 2019.

### FIELD OF THE DISCLOSURE

The present disclosure generally relates to software applications on a portable client device that implement an accelerometer to receive user inputs.

### BACKGROUND

Many portable devices (e.g., tablets, smart phones) are equipped with an accelerometer that can detect an angular velocity and/or changes to the angular velocity of the device. The accelerometer may be implemented in a variety of applications including orienting the device during GPS navigation, adjusting the screen display based on the orientation of the device, and manipulating controls in games (e.g., steering a car in a racing game)

### SUMMARY

In accordance with a first aspect, a computer-implemented method for presenting a display on a client device based on a rotation event of the client device is described. The method includes displaying a media file on a screen of the client device, detecting a rotation event of the client device with a rotation measurement device from a first orientation to a spinning state, and stabilizing at least a portion of a display on the screen of the client device in the first orientation while the client device is in the spinning state.

According to one form, stabilizing the at least a portion of the display on the screen of the client device in the first orientation while the client device is in the spinning state can include stabilizing the media file in the first orientation, such that outer portions of the media file are displayed within an annular outer path of edge portions of the client device in the spinning state.

According to another form, stabilizing the at least a portion of the display on the screen of the client device in the first orientation while the client device is in the spinning state can include stabilizing a panel in a central portion of the screen and displaying the media file spinning around the panel while the client device is in the spinning state. In a further form, the method can include displaying measurement data, such as a timer for the spinning state and/or rotational speed measurement data, in the panel.

According to some forms, the method can include providing a reset button to stop the stabilization of the at least a portion of the display on the screen of the client device and/or inserting at least one of alphanumeric or graphical content on the media file.

In accordance with a second aspect, a portable computing device is described that includes a rotation measurement device configured to measure rotation of the portable computing device, a screen, and a processing device coupled to the rotation measurement device and the screen. The processing device is configured to display a media file on the screen, detect a rotation event of the portable computing device based on data measured by the rotation measurement device from a first orientation to a spinning state, and stabilize at least a portion of a display on the screen in the first orientation while the portable computing device is in the spinning state.

According to one form, the processing device can be configured to stabilize the media file in the first orientation, such that outer portions of the media file area are displayed within an annular outer path of edge portions of the portable computing device in the spinning state.

According to another form, the processing device can be configured to stabilize a panel in a central portion of the screen and display the media file spinning around the panel while the portable computing device is in the spinning state. In a further form, the processing device can be configured to display measurement data in the panel. In some examples, the measurement data can be a timer for the spinning state and/or rotational speed measurement data.

According to some forms, the portable computing device can include a user input, which can include a reset button, and the processing device can be configured to reset the screen to a normal display to stop the stabilization of the at least a portion of the media file upon reception of a selection of the reset button and/or the processing device can be configured to insert at least one of alphanumeric or graphical content on the media file in response to selection of the user input.

In accordance with a third aspect, a computer-implemented method for presenting a display on a client device based on a rotation event of the client device is described herein. The method includes detecting a rotation event of the client device with a rotation measurement device to a spinning state and spinning at least a portion of a display on the screen of the client device at at least one of a different rate or different direction than the client device in the spinning state.

According one form, spinning the at least a portion of the display on the screen of the client device can include spinning an image having a direction selection portion in a central portion of the screen.

According to some forms, the method can include stopping the spin of the at least a portion of the display on the screen in response to the spinning state ending or after a predetermined amount of time has passed. In a further form, the method can include stabilizing the orientation of the at least a portion of the display after stopping the spin of the at least a portion of the display on the screen. In yet a further form, the method can include providing a reset button to stop the stabilization of the at least a portion of the display.

In accordance with a fourth aspect, a portable computing device is described that includes a rotation measurement device configured to measure rotation of the portable computing device, a screen, and a processing device coupled to the rotation measurement device. The processing device is configured to detect a rotation event of the client device with a rotation measurement device to a spinning state and spin at least a portion of a display on the screen of the client device at at least one of a different rate or different direction than the client device in the spinning state.

According one form, the processing device configured to spin at least a portion of a display on the screen of the client device can include the processing device configured to spin an image having a direction selection portion in a central portion of the screen.

According to some forms, the processing device can be further configured to stop the spin of the at least a portion of the display on the screen in response to the spinning state ending or after a predetermined amount of time has passed. In a further form, the processing device can be further configured to stabilize the orientation of the at least a portion of the display after stopping the spin of the at least a portion of the display on the screen.

According to some forms, the portable computing device can include a user input including a reset button and the processing device can be configured to reset the screen to a normal display to stop the stabilization of the at least a portion of the display upon reception of a selection of the reset button.

According to any of the above forms, the portable computing device can include an expandable/collapsible grip accessory affixed to a back portion of the portable computing device by a securing element, where the expandable/collapsible grip accessory includes a rotating portion that is capable of allowing the portable computing device to rotate around an axis while another portion of the expandable/collapsible grip accessory remains still. In further forms, the expandable/collapsible grip accessory can include a cover forming a tapered shape connected to the securing element, the cover capable of extending outward generally along its axis from the portable media player and retracting back toward the portable computing device by collapsing generally along its axis and a foot disposed at the distal end of the cover; and, optionally, the cover of the grip accessory can have rigid walls interspersed with flexural hinges.

### BRIEF DESCRIPTION OF THE DRAWINGS

FIG. 1 is a diagram of an example computing environment in accordance with various embodiments;

FIG. 2 is a schematic view of a base graphical user interface (GUI) for application software operating on a client device in accordance with various embodiments;

FIG. 3 is a schematic view of a first example GUI for application software showing a portable client device in a spinning configuration with a stabilized display in accordance with various embodiments;

FIG. 4 is a schematic view of the first example GUI showing the portable client device in a stopped configuration;

FIG. 5 is a schematic view of a second example GUI for application software showing a portable client device in a spinning configuration with a stabilized icon in accordance with various embodiments;

FIG. 6 is a schematic view of the second example GUI showing the portable client device in a stopped configuration;

FIG. 7 is a schematic view of a third example GUI for application software showing a portable client in a spinning configuration with an icon rotating at a different rate than the portable client device in accordance with various embodiments; and

FIG. 8 is a schematic view of the third example GUI showing the portable client device in a stopped configuration; and

FIG. 9 is a perspective view of a client device with a grip attachment coupled thereto in accordance with various embodiments.

### DETAILED DESCRIPTION

Portable client devices, software operating on such devices, and methods are described herein that utilize rotational data of the device to at least partially control the output on a display of the device, such as images and/or video, operating on the device. More specifically, when operating the software, an accelerometer and/or gyroscope within the device can determine when a user rotates or spins the device and, in some versions, how fast a user rotates or spins the device, and thereafter a processing device can cause media to be displayed using rotational characteristics as input. The processing device can utilize the rotational characteristics, such as spin direction, spin speed, spin rate of change, and the like, to cause components on the display to stay stationary with respect to the moving client device and/or spin at a different rate of speed and/or in a different direction. The software described herein is particularly suitable for being implemented on a portable client device affixed with a rotating accessory to enable users to easily rotate the client device for media output.

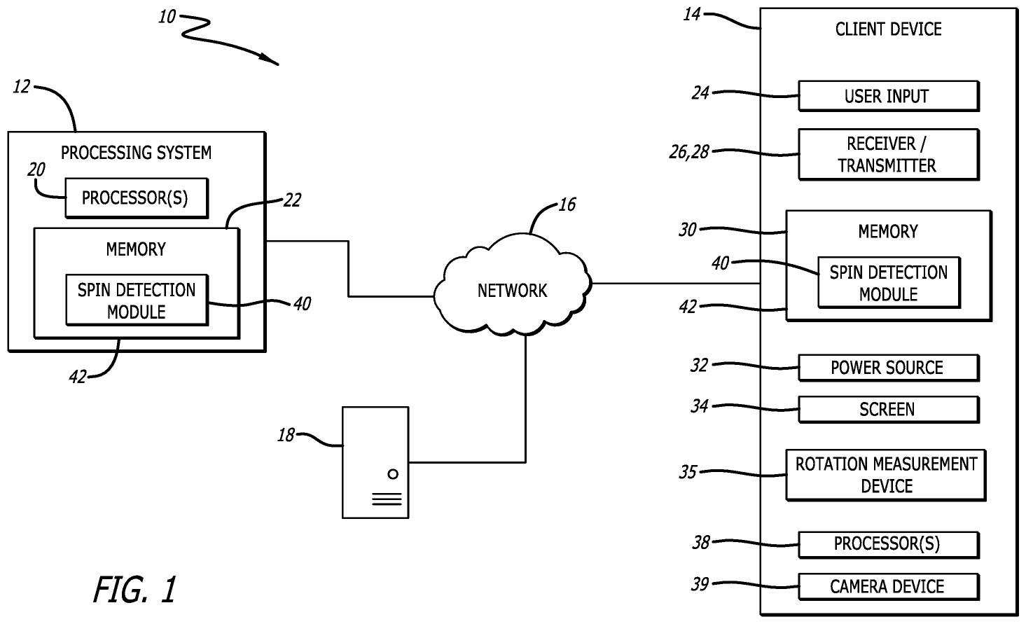

FIG. 1 illustrates one exemplary computing environment 10 in which the client device of the present disclosure may operate. In the computing environment 10, a processing system 12 can communicate with various client devices (e.g., client device 14), application servers, web servers, and other devices via a communication network 16, which can be any suitable network, such as the Internet, WiFi, radio, Bluetooth, NFC, etc. The processing system 12 includes one or more servers or other suitable computing devices. The communication network 16 can be a wide-area network (WAN) or a local-area network (LAN), for example, and can include wired and/or wireless communication links. A third-party server 18 can be any suitable computing device that provides web content, applications, storage, etc. to various client devices 14. The content can include media, such as images and/or video, in any suitable file format.

As illustrated in FIG. 1, the processing system 12 can include one or more processing devices 20 and a memory 22. The memory 22 can include persistent and non-persistent components in any suitable configuration. If desired, these components can be distributed among multiple network nodes. The client device 14 can be any suitable portable computing device, such as a mobile phone, tablet, E-reader, and so forth. The client device 14 can be configured as commonly understood to include a user input 24, such as a touch screen, keypad, switch device, voice command software, or the like, a receiver 26, a transmitter 28, a memory 30, a power source 32, which can be replaceable or rechargeable as desired, a screen 34, a rotation measurement device 35, which can be an accelerometer 36 and/or a gyroscope 37, a processing device 38 controlling the operation thereof, and a camera device 39. The gyroscope 37 may be configured to periodically or continuously measure rotational characteristics of the device 14, including an orientation and angular velocity of the client device 14, and the accelerometer 36 may be configured to periodically or continuously measure rotational characteristics of the device 14, including a general rotation, a stopping of rotation, an angular velocity, a rate of change, a direction of orientation and movement, and/or determine an orientation of the device 14 in a three-dimensional space. The memory 30 can include persistent and non-persistent components. As commonly understood, the components of the device 14 are connected by electrical pathways, such as wires, traces, circuit boards, and the like.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein

The client device 14 includes a spin detection module 40 stored in the memory 30 as a set of instructions executable by the processing device 38. The spin detection module 40 is configured to analyze measurements from the rotation measurement device 35 to identify rotational characteristics of the client device 14. If desired, the functionality of the spin detection module 40 also can be implemented as a spin detection module application programming interface (API) 42 stored in the memory 30 that can include any content that may be suitable for the techniques of the current disclosure, which various applications executing on servers and/or client devices can invoke. For example, the API 42 may perform a corresponding action to display or alter displayed media on the client device in response to a rotation event of the client device detected by the spin detection module 40. The spin detection module 40, as set forth below, can invoke the API 42 when necessary, without having to send data to the processing system 12.

By another approach, the memory 22 of the processing system 12 stores instructions that implement a spin detection module 40 configured to receive and transmit data corresponding rotation events and actions measured by the rotation measurement device 35 of the client device 14 and third party servers 18. The spin detection module 40 may be implemented on the processing system 12, the client device 14 as discussed above, or in any suitable combination for setting and/or implementing the one or more display and/or media manipulation actions triggered by a rotation event. The rotation event can be when the device rotates, such as in a clockwise and/or counterclockwise direction, based on a speed of rotation, based on an acceleration or slowdown of rotation, based on a stopped rotation, and so forth.

The processing system 12 may receive spin data or measurements from the client device 14 corresponding to the various triggered actions from the client device 14. For example, the third-party server 18 can provide media to be displayed or played on the client device 14 and manipulated using the spin detection module 40 and request that the processing system 12 process rotation data received from the client device 14. As another example, the client device 14 can select one or more actions to be performed in response to a rotation event from a preset list provided by the processing system 12.

The media being displayed, and optionally altered, according to a given rotation event can be an image, gif, or video, whether stored locally or being provided by the third party server 18. The image, gif, or video can further be captured using the camera device 39 through the API 42 or selected from pre-saved images/videos.

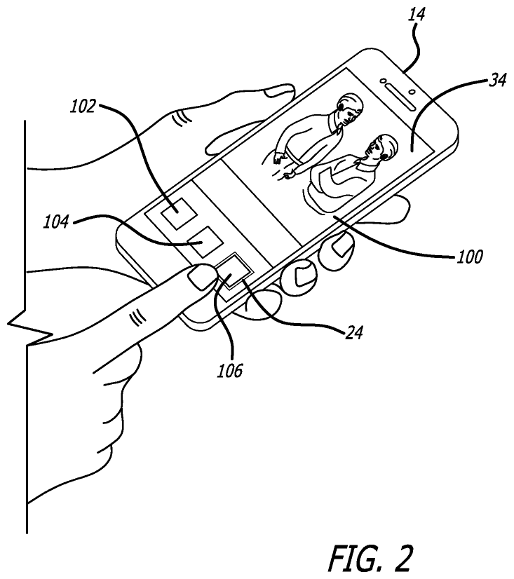

A client device 14 having graphical user interfaces (GUIs) with example display actions provided by application software operating on the client 14 is shown in FIGS. 2-8. The software can provide and display a base GUI 100 having icons 102, 104, 106 for each of the display actions on the screen 34. Of course, it will be understood that any of the GUIs can be provided in different groups, as standalone software, or each of the GUIs can include icons to access the others. To select a desired display action, a user can select one of the icons 102, 104, 106 with the user input 24 corresponding to a desired application setting or functionality.

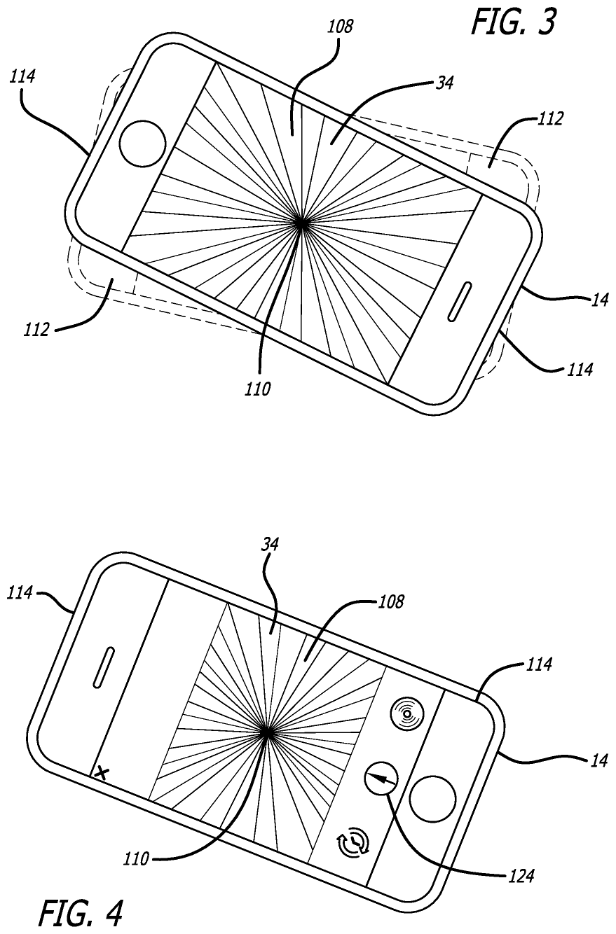

Upon selection of the first icon 102, as shown in FIGS. 3 and 4, the processing device 38 can cause the screen 34 to display a first GUI 108 corresponding to a stabilized media file display action. The screen 34 can show a preselected default or user-selected media file or can prompt a user to select a media file to display on the screen 34. The file can be selected from the OS photo library or other file, or captured with the camera device 39, for example. The processing device 38 creates a display of the media file in a first orientation corresponding to the orientation of the client device 14 upon entry to the first GUI 108.

Thereafter, the user can spin the client device 14 from the first orientation to create a rotation event. Upon the detection module 40 detecting the rotation event, the processing device 38 holds the display of the media file in the first orientation so that the media file is stabilized with respect to the spinning client device 14. As shown in FIG. 3, in versions where the client device 14 has an oblong configuration with a height and width with different dimensions, the spinning client device 14 will have a continuously displayed central circular spinning area 110 and radially outward annular areas 112 where outer portions 114 of the client device 14 sequentially pass therethrough in the direction of rotation. The display of the media file is held in the first orientation so that portions thereof extending into the outward annular areas 112 are only visible when the outer portions 114 of the client device 14 pass through the corresponding portion of the annular areas 112.

The client device 14 can continue to spin until coming to a stop naturally or a user can physically stop the client device 14 from spinning. Upon detection of the stopped rotation by the detection module 40 the processing device 38 can stop stabilization of the media file and return the screen 34 to a normal display. Alternatively, as shown in FIG. 4, the first GUI 108 can include a reset button 124 that resets the screen 34 to a normal display.

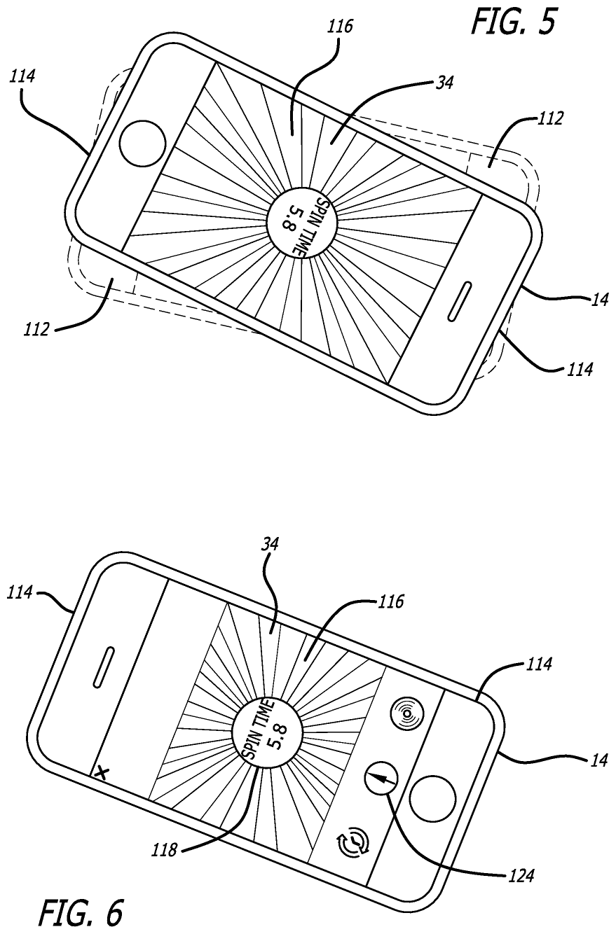

Upon selection of the second icon 104, as shown in FIGS. 5 and 6, the processing device 38 can cause the screen 34 to display a second GUI 116 corresponding to a stabilized panel display action. The screen 34 can show a preselected default or user-selected media file or can prompt a user to select a media file to display on the screen 34. The file can be selected from the OS photo library or other file, or captured with the camera device 39, for example. The processing device 38 displays the media file on the screen upon entry or selection to the second GUI 116. Further, the second GUI 116 includes a panel or window portion 118, which can be generally centrally disposed on the screen 34 as shown. The processing device 38 displays the panel 118 in a first orientation corresponding to the orientation of the client device 14 upon entry to the second GUI 116.

Thereafter, the user can spin the client device 14 to create a rotation event. Upon the detection module 40 detecting the rotation event, the processing device 38 holds the display of the panel 118 in the first orientation so that the panel 118 is stabilized with respect to the spinning client device 14 and the background display of the media file. The client device 14 can continue to spin until coming to a stop naturally or a user can physically stop the client device 14 from spinning, at which point the detection module 40 can detect the stopped rotation event. Upon detection of the stopped rotation event, the processing device 38 can stop stabilization of the panel 118 and return the screen 34 to a normal display or, as shown in FIG. 6, the second GUI 116 can include a reset button 124 that resets the screen 34 to a normal display.

The panel 118 can take any desired form. In one version, the panel 118 can display a timer that begins on detection of the rotation event and stops on detection of the stopped rotation event. This allows a user to easily time how long they can spin the client device 14. In another version, the panel 118 can display a measurement corresponding to the rotation event, such as a revolutions per time unit, e.g., rpm, of the client device 14, an angular velocity of a portion of the client device 14, etc. This allows a user to easily determine how fast they can spin the client device 14. In yet another version, the panel 118 can be a different media file than the background.

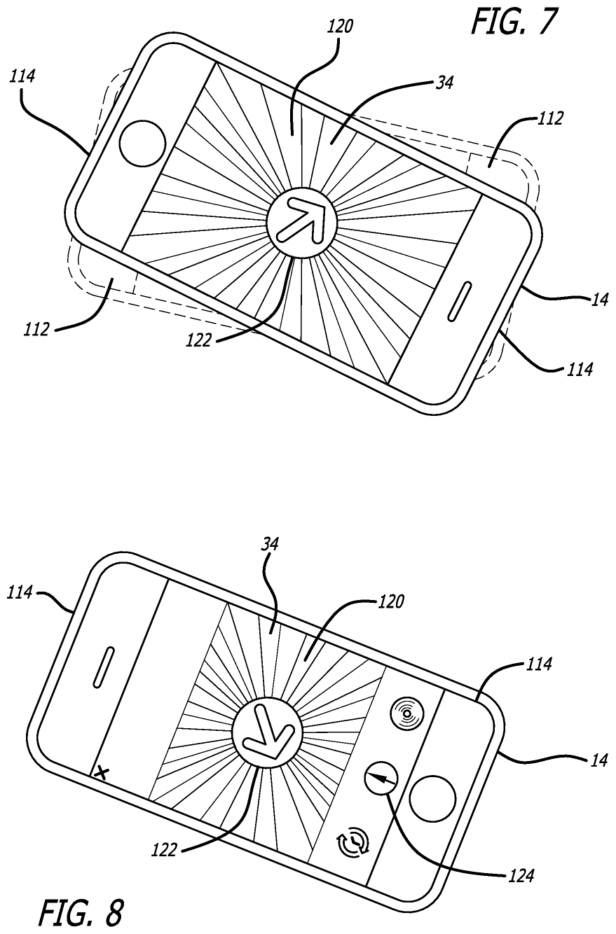

Upon selection of the third icon 106, as shown in FIGS. 6 and 7, the processing device 38 can cause the screen 34 to display a third GUI 120 corresponding to a spinning panel display action. The screen 34 can show a preselected default or user-selected media file or can prompt a user to select a media file to display on the screen 34. The file can be selected from the OS photo library or other file, or captured with the camera device 39, for example. The processing device 38 displays the media file on the screen upon entry or selection to the third GUI 120. Further, the third GUI 120 includes a panel or window portion 122, which can be generally centrally disposed on the screen 34 as shown. The processing device 38 can display the panel 122 in an orientation independent from the orientation of the client device 14, at a fixed rate of rotation different than the client device 14, at a random rate of rotation with respect to the client device 14, or at a variable rate of rotation upon entry to the third GUI 120 or on detection of a rotation event.

Thereafter, the user can spin the client device 14 from the first orientation to create a rotation event. Upon the detection module 40 detecting the rotation event, the processing device 38 can spin the display of the panel 118 at a different, variable, or random rate and/or direction of rotation than the client device 14 and the background display of the media file. The spin of the panel 118 can be based on a speed of rotation of the client device or independent therefrom. The client device 14 can continue to spin until coming to a stop naturally or a user can physically stop the client device 14 from spinning, at which point the detection module 40 can detect the stopped rotation event. Upon detection of the stopped rotation event, the processing device 38 can stop the rotation of the panel 122 or allow the panel 122 to continue spinning for a predetermined amount of time. In the latter form, the processing device 38 can sequentially slow down the rotation of the panel 122 until the panel 122 stops spinning. In an alternative form, the panel 122 can stop spinning prior to the stopped rotation event of the client device 14. Regardless, the processing device 38 can cause the panel 122 to be stabilized in the stopped orientation with respect to any further movement of the client device 14. Accordingly, a user can stop rotation of the client device 14 and/or otherwise move the client device 14 around and the panel 122 will hold the stopped orientation.

The panel 122 can take any desired form. In one version, the panel 122 can have a direction selection portion, such as an arrow, that can be utilized to select an area disposed around the client device 14. This functionality can be utilized to select a specific person of a group of people or other object of a group of objects surrounding the client device 14. If desired, the media file can divide the background display into wedges, such that the arrow can point to one of the wedges on the background display in the stopped orientation. The third GUI 120 can also provide a reset button 124 selectable by the user input 24 to stop the stabilization of the panel 122 and return the screen 34 to a normal display.

One or more of the GUIs 108, 116, 120 can include display options for selection by the user using the user input 24, which can include inserting alphanumeric and/or graphical content, such as text, stickers, emoticons or other graphics, cropping, resizing, altering color/contrast characteristics, and so forth. The API 42 can take any tags and/or settings into account, as well as parameters that include any modifiers, filters, and/or effects selected or assigned for the particular GUI 108, 116, 120.

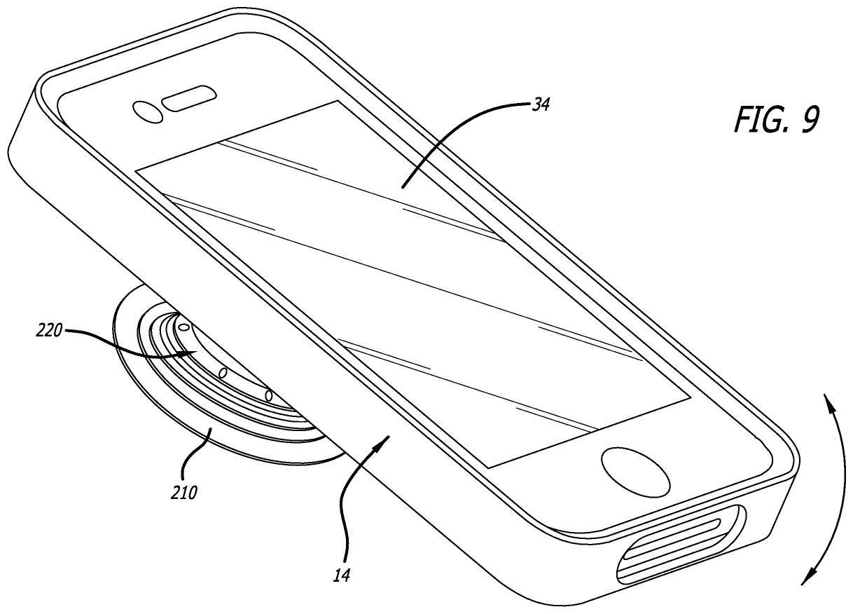

For many approaches, the functionalities described herein can be utilized by a user twisting the client device 14 in a hand, spinning the client device 14 on a surface, and so forth. To further enable a user to easily rotate, spin, and manipulate the rotation of the client device 14, the device 14 may be affixed with an expandable/collapsible grip accessory 210, as illustrated in FIG. 9. FIG. 9 schematically illustrates a client device 14 affixed with a grip accessory 210. The grip accessory 210 may include a rotating portion 220, which can include bearings, low-friction couplings, etc., that allows the client device 14 to spin freely relative to the remainder of the grip accessory 210, when the grip accessory 210 is held in a user's hand or placed on a surface, for example. In some instances, the grip accessory 210 of the current disclosure may include, at least in part, an extending grip accessory for a portable media player or portable media player case as disclosed in U.S. Pat. No. 8,560,031, or U.S. Publication No. 2018/0288204, entitled “Spinning Accessory for a Mobile Electronic Device,” the entire disclosures of which are incorporated herein by reference.

The application software described herein can be available for purchase and/or download from any website, online store, or vendor over the communication network 16. Alternatively, a user can download the application onto a personal computer and transfer the application to the client device 14. When operation is desired, the user runs the application on the client device 14 by a suitable selection through the user input 24.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A computer-implemented method for presenting a display on a client device based on a rotation event of the client device, the method comprising:
displaying a media file on a screen of the client device;
detecting a rotation event of the client device with a rotation measurement device from a first orientation to a spinning state; and
stabilizing at least a portion of a display on the screen of the client device in the first orientation while the client device is in the spinning state.

2. The computer-implemented method of claim 1, wherein stabilizing the at least a portion of the display on the screen of the client device in the first orientation while the client device is in the spinning state comprises stabilizing the media file in the first orientation, such that outer portions of the media file are displayed within an annular outer path of edge portions of the client device in the spinning state.

3. The computer-implemented method of claim 1, wherein stabilizing the at least a portion of the display on the screen of the client device in the first orientation while the client device is in the spinning state comprises stabilizing a panel in a central portion of the screen and displaying the media file spinning around the panel while the client device is in the spinning state.

4. The computer-implemented method of claim 3, further comprising displaying measurement data in the panel.

5. The computer-implemented method of claim 4, wherein displaying the measurement data in the panel comprises displaying a timer for the spinning state and/or rotational speed measurement data.

6. The computer-implemented method of claim 1, further comprising inserting at least one of alphanumeric or graphical content on the media file.

7. A portable computing device comprising:
a rotation measurement device configured to measure rotation of the portable computing device;
a screen; and
a processing device coupled to the rotation measurement device and the screen, the processing device configured to:
display a media file on the screen;
detect a rotation event of the portable computing device based on data measured by the rotation measurement device from a first orientation to a spinning state; and
stabilize at least a portion of a display on the screen in the first orientation while the portable computing device is in the spinning state.

8. The portable computing device of claim 7, wherein the processing device configured to stabilize the at least a portion of the display on the screen in the first orientation while the portable computing device is in the spinning state comprises the processing device configured to stabilize the media file in the first orientation, such that outer portions of the media file area are displayed within an annular outer path of edge portions of the portable computing device in the spinning state.

9. The portable computing device of claim 7, wherein the processing device configured to stabilize the at least a portion of the display on the screen in the first orientation while the portable computing device is in the spinning state comprises the processing device configured to stabilize a panel in a central portion of the screen and display the media file spinning around the panel while the portable computing device is in the spinning state.

10. The portable computing device of claim 9, wherein the processing device is further configured to display measurement data in the panel.

11. The portable computing device of claim 10, wherein the processing device configured to display the measurement data in the panel comprises the processing device configured to display a timer for the spinning state and/or rotational speed measurement data in the panel.

12. The portable computing device of claim 7, further comprising a user input; and wherein the processing device is further configured to insert at least one of alphanumeric or graphical content on the media file in response to selection of the user input.

13. The portable computing device of claim 7, further comprising an object affixed to the portable computing device, wherein the object comprises a rotating portion and a non-rotating portion, wherein the rotating portion of the object is configured to rotate about an axis in coordination with the rotation event of the portable computing device while the non-rotating portion remains still.

14. The portable computing device of claim 13, wherein the object is a bearing-based object.

15. The portable computing device of claim 13, wherein the object comprises an expandable/collapsible grip accessory affixed to a back portion of the portable computing device by a securing element.

16. The portable computing device of claim 13, wherein the object comprises:
a cover forming a tapered shape connected to a securing element, the cover capable of extending outward generally along its axis from the portable media player and retracting back toward the portable computing device by collapsing generally along its axis; and
a foot disposed at the distal end of the cover.

17. A computer-implemented method for presenting a display on a client device based on a rotation event of the client device, the method comprising:
detecting a rotation event of the client device with a rotation measurement device to a spinning state; and
spinning at least a portion of a display on the screen of the client device at a different rate and/or direction than the client device in the spinning state.

18. The computer-implemented method of claim 17, wherein spinning the at least a portion of the display on the screen of the client device comprises spinning an image having a direction selection portion in a central portion of the screen.

19. The computer-implemented method of claim 17, further comprising stopping the spin of the at least a portion of the display on the screen in response to the spinning state ending or after a predetermined amount of time has passed.

20. The computer-implemented method of claim 17, further comprising stabilizing the orientation of the at least a portion of the display after stopping the spin of the at least a portion of the display on the screen.
